(19) United States
(12) Patent Application Publication
(10) Pub. No.: US 2019/0381853 A1
(43) Pub. Date: Dec. 19, 2019

(54) Piezo-Electric Air Spring

(71) Applicant: Hashem Keshavarzmoayedi, Las Vegas, NV (US)

(72) Inventor: Hashem Keshavarzmoayedi, Las Vegas, NV (US)

(21) Appl. No.: 16/009,514

(22) Filed: Jun. 15, 2018

(51) Int. Cl. B60G 17/019; B60G 17/015; G01G 19/12

(52) U.S. Cl. CPC B60G 17/01941; B60G 17/0155; B60G 2401/10; B60G 2400/60; G01G 19/12

(57) ABSTRACT

A piezo-electric air spring, comprising an air spring and a piezo-electric sensor for generating electrical charges to determine the weight of a semi-trailer.

### CROSS-REFERENCE TO RELATED APPLICATION(S)

Not applicable.

### BACKGROUND OF THE INVENTION

### 1. Field of Invention

The present invention relates to the field of truck trailer, more particularly to an axel mounted weighing device.

### 2. Description of Related Art

Most states individually collect taxes based on the weight of transported goods passing over the roadways within their boundaries and regulate the allowed weight of trucks on roadways within their boundaries. Truck weigh stations are used for these tax purposes as well as to monitor the weight of a truck to ensure that it falls within the weight and safety guidelines that each state has in place for its road system. Generally, most states require the weighing of 1) commercial vehicles, and/or 2) vehicles over a certain weight. Trucks exceeding the weight restrictions for the state must pay a fee, and for the most part the maximum gross weight in the U.S. for a vehicle is 80,000 lbs.

A weigh station is a designated location, typically located directly off highways, where the Department of Transportation or state highway patrol inspects the weight of a vehicle, and weigh stations can become extremely congested and can cost drivers precious time, not to mention waste fuel from idling while awaiting their turn for weighing. Most weigh stations have a rolling scale where a truck will roll past a certain area that has a scale (could differ by state). Once a truck is weighed and verified to weigh under 80,000 pounds, the truck will be granted a green light to exit the weigh station and proceed back on its route. Fuel fees and excess weight fees can be accessed and billed automatically. However, in some circumstances, the driver may be required to pull over and shut down the rig to pay weight fees.

After a truck goes through the scales either the DOT or state inspection officer can flag the truck for an inspection. At a weigh station, trucks can be inspected for a variety of reasons. DOT officers or Federal Motor Carrier Safety Administration agents conduct a thorough equipment safety inspection to find issues with a truck including: low or flat tires, tire tread, oil, fuel or anti-freeze leaks, brake malfunctions, broken springs, securely mounted fuel tanks, cracks in wheels and rims, unlocked kingpin, and hose or tubing leaks.

All this activity within a weigh station can lead to significant down time that cost money and is only compounded when a driver's rig is flagged for being overweight and must pay overage fees. Often, overage fees come as a surprise, as most drivers strive to stay within weight limitations. For independent driver-operators, overweight fees can significantly increase costs cutting into profitability.

There is a need for an improved semi-trailer weight measurement system. A system that provides cargo weight on a loaded truck-trailer after loading would minimize overage fees if not eliminate them altogether. A system that allows a driver to accurately determine a vehicle weight before departing a loading point can allow for removing cargo to get down to a required maximum weight.

Air springs are the means most semi-trailers use to absorb shock on roadway driving. Each axel usually has two air springs, one for each left and right wheel set. The weight of the trailer and its load is transmitted through the air springs. If each air spring is mechanized to capture and relay the amount of weight passing through it, a total weight can be calculated. U.S. Pat. No. 7,572,988 takes advantage of air springs for just this purpose, proposing an on-board weight measurement system using the changes in air pressure within each air spring. However, U.S. Pat. No. 7,572,988 is limited to the measurement of air pressure, and even then, the patent fails to specifically identify the physical mechanics of air pressure measurement

The invention proposed in this application uses another means besides air pressure to measure trailer weight, and more importantly, offers a very specific, proven mechanism for accurate weight measurement. The proposed means is a piezo-electric sensor incorporated into the top plate assembly of the air spring. A piezo-electric sensor consists of material which generates an electrical charge when subject to pressure. The electrical charge changes proportionately to the pressure applied. U.S. Pat. No. 4,793,429 teaches that, when placed between metallic plates, the electrical charge generated by piezo-electric material can be translated into a weight measurement using the equation weight=q·d33, where q is the total charge signal and d33 is the thickness sensitivity of the piezo material. Hence, the electrical signal can be converted, by way of signal measurement and computation, to a weight measurement, then broadcast to a display.

The invention comprises an air spring with a piezo-electric sensor and a means to transmit electrical signals from the piezo-electrical sensor.

The foregoing, and other features and advantages of the invention will be apparent from the following, more particular, description of the preferred embodiments of the invention, the accompanying drawings, and the claims.

### BRIEF DESCRIPTION OF THE DRAWINGS

For a more complete understanding of the present invention, and the objects and advantages thereof, reference is now made to the ensuing descriptions taken in connection with the accompanying drawings, briefly described as follows:

FIG. 1 is a drawing of an air spring with a piezo-electric sensor.

FIG. 2 is a drawing of an exploded view of an air spring with a piezo-sensor mounted to a trailer.

### DETAILED DESCRIPTION OF PREFERRED EMBODIMENTS

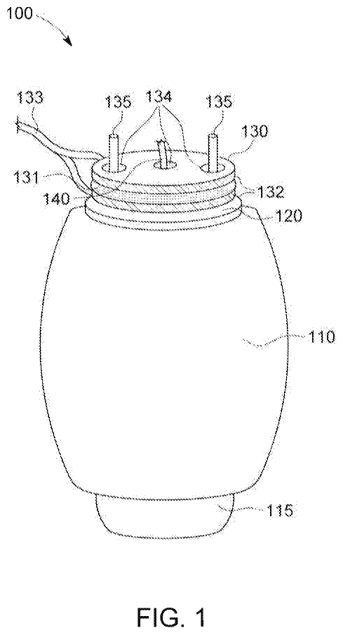

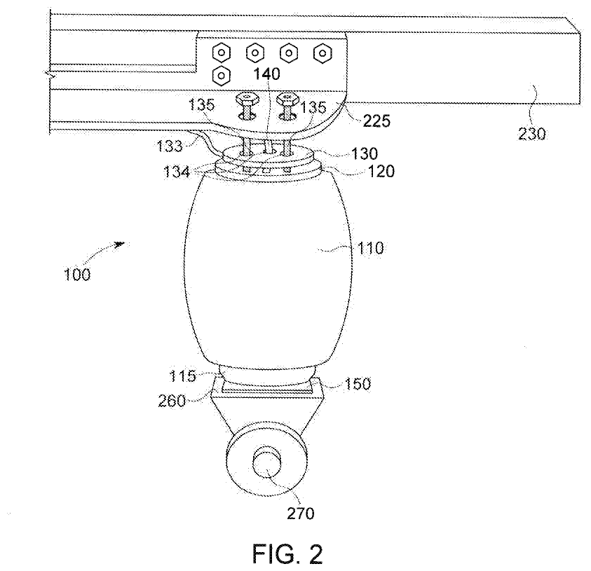

Preferred embodiments of the present invention and their advantages may be understood by referring to FIGS. 1-2, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs: Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

FIG. 1 is a piezo-electric air spring 100, showing the rubber bellows 110 and bellows piston 115, capped by the top plate 120 and the piezo sensor 130. The piezo sensor is comprised of piezo material 131, sandwiched between conducting plates 132 with signal transmittal wires 133, and having openings 134 for the passage of the mounting stems 135 and the air hose 140.

FIG. 2 is an exploded view showing the mounting of a piezo-electric air spring 100 to a trailer. A piezo-electric sensor 130 with signal transmittal wires 133 is positioned between the top plate 120 and the air spring trailer mounting bracket 225. The trailer mounting bracket connects the air spring to a trailer support beam 230. The trailer support beam 230 runs longitudinally along the bottom of a semi-trailer, bearing and transmitting the weight of the trailer, and its load, through the piezo-electric sensor 130 and down onto the air spring 100. The bellows piston 115 attaches to the bottom plate 150, which attaches to a bottom trailer mounting bracket 260. Below that is an axle 270.

The invention has been described herein using specific embodiments for the purposes of illustration only. It will be clear to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A piezo electric air spring, comprising an air spring and a piezo electric sensor,
a) wherein the air spring comprises a top plate, at least two mounting stems for attaching to the support beam of a semi trailer, and an air hose for inflating and pressurizing the air spring,
b) wherein the piezo electric sensor is attached to the top plate of the air spring and has openings for the passage of the mounting stems and the air hose, and
c) wherein the piezo electric sensor comprises a wiring means for transmitting an electrical signal.
